(19) United States
(12) Patent Application Publication
(10) Pub. No.: US 2003/0108297 A1
(43) Pub. Date: Jun. 12, 2003

(54) High density integrated fiber optics add/drop modules and wavelength division multiplexers

(75) Inventor: Bing-Huan Lee, Kaohsiung (CN)

Correspondence Address: BACON & THOMAS, PLLC, 625 Slaters Lane 4th Floor, Alexandria, VA, 22314-1176, US

(73) Assignee: Contrel Semiconductor Technology Co., Ltd., Taiwan (CN)

(21) Appl. No.: 10/202,834

(22) Filed: Jul. 26, 2002

(30) Foreign Application Priority Data
Dec. 7, 2001 (TW) 90130304

(51) Int. Cl. G02B 6/26; G02B 6/32; G02B 6/293

(52) U.S. Cl. 385/47; 385/33; 385/24

(57) ABSTRACT

A fiber optics wavelength add/drop module and wavelength division multiplexer is presented based on multi-fiber collimators. In one embodiment, the device has a total of six input/output fibers to resemble a dual three-port add/drop devices configuration. In another embodiment, the devices are cascaded to make an integrated multiplexer/demultiplexer module. In another embodiment, the output fibers are connected by special fibers to produce a miniature bend to form a compact device. The configuration can raduce the number of components by at least a factor of two, thus reducing the cost and size, and enhancing the reliability.

A fiber optics wavelength add/drop module and wavelength division multiplexer is presented based on multi-fiber collimators. In one embodiment, the device has a total of six input/output fibers to resemble a dual three-port add/drop devices configuration. In another embodiment, the devices are cascaded to make an integrated multiplexer/demultiplexer module. In another embodiment, the output fibers are connected by special fibers to produce a miniature bend to form a compact device. The configuration can raduce the number of components by at least a factor of two, thus reducing the cost and size, and enhancing the reliability.

### FIELD OF THE INVENTION

The present invention relates to wavelength division mulitplexers (WDM) and optical wavelength add/drop modules, and, in particular, to high density integrated WDM devices based on micro-optics with thin-film filter structures.

### BACKGROUND OF THE INVENTION

When the information communication within the modem human society is growing and becoming more sophisticated each day, the need to increase data transmission capacity has become one of the most important issues in the technology world. However, both physical and economic constraints can limit the feasibility of increasing transmission capacity. For example, installing additional fiber optic cable to support additional signal channels can be cost prohibitive, and electronic system components may impose physical limitations on the speed of information (i.e. data rates) that can be transmitted. The use of wavelength division multiplexers (WDMs) provides a simple and economical way to increase the transmission capacity of fiber optic communication systems by allowing multiple wavelengths to be transmitted and received over a single optical fiber through wavelength multiplexing and demultiplexing. Coarse WDM (CWDM) and Dense WDM (DWDM) are the most common versions today. The difference of the two types is distinguished by the spectral separation of the transmission signals, the former having a wider channel separation and allowing the use of un-cooled laser transmitters, and the later having a smaller channel separation and thus requiring cooled lasers to precisely control the emitted wavelength within the WDM spectral pass-band. In addition, WDMs can be used in metro or local fiber optic communication networks, while the data link is no longer a point-to-point, but a ring or mesh configuration. In this case, dropping or adding a wavelength signal at a random location becomes an important issue for such a complicated network. Therefore, optical add/drop modules (OADM) are equally important as multiplexers and demultiplexers in the future WDM optical network systems.

OADMs and WDMs can be manufactured using micro-optics technology and dielectric thin-film filters, as demonstrated in U.S. Pat. No. 6,198,858 B1 for example. As shown in FIG. 1(a), a dual-fiber collimator 108, consisting a dual-fiber pig-tail 103 and a collimating lens 102 (e.g. graded-index (GRIN) lens, or any other convex focusing lenses), receives the input light from input fiber 105, which contains several wavelength signals. The dielectric thin-film wavelength filter 101 passes a specific wavelength λ which is then collected by the second single-fiber collimator 109 with lens 102 into output fiber 107 of second pig-tail 104. The remaining wavelengths (not equal to λ) are reflected back to the first collimator into output fiber 106. The 3-port OADM device described above thus provides a “drop” function. If we reverse the light signal traveling direction, a signal of wavelength λ inserted into fiber 107 of second pig-tail 104 can be added to fiber 105, when a group of wavelengths not equal to λ are inserted into fiber 106, thus performing an “add” function. Therefore, this device can be an optical “add-OR-drop” module depending on the signal traveling direction. For a bandpass type filter, the drop (or add) spectrum is shown by the solid line 110 in FIG. 1(d), and the reflected spectrum is shown by the dashed line 111. The whole structure is then fixed within a rigid housing either by epoxy or soldering method to provide mechanical stability. This structure has been proven in the past several years in the industry to provide a reliable OADM device with good resistance to moisture and environmental temperature stresses.

Using the two identical devices of FIG. 1(a), we can easily implement an “add-AND-drop” module. For example, FIG. 1(b) shows a 4-port add-and-drop module consisting of two identical 3-port OADMs 100 by connecting the two output fibers 106-1 and 106-2 of OADM 100-1 and 100-2 together. In this case, a wavelength signal λ is initially dropped by OADM 100-1 to output fiber 107-1. The remaining wavelengths are reflected to fiber 106-2 and input to fiber 106-2 of the second 3-port OADM 100-2. As mentioned above by using the OADM as an “Add” module, a new signal of the same wavelength λ is added to the remaining signals by OADM 100-2 to output fiber 105-2. This structure, therefore, becomes a four-port OADM. It should be noted that, because the original signal is reflected by the thin-film filter twice (within OADM 100-1 and 100-2), the in-band isolation (i.e. the power difference between the original dropped wavelength and the remaining wavelengths seen at the output port 105-2) is doubled as shown by the solid line 112 in FIG. 1(d), compared to the single reflection spectrum denoted by dashed line 111. This is important because most dielectric thin-film filters have less than 15 dB of reflection in-band isolation, not enough to sufficiently eliminate the cross talk produced by the original dropped signal. By doubling the in-band isolation one can get a number of greater than 25 dB, sufficient for most applications. The drop and add spectra remain the same as shown by solid line 110.

One can also use the 3-port OADM 100 to create a multi-channel multiplexer or demultiplexer. As shown in FIG. 1(c), an n-port WDM is made using n cascaded OADMs 100-λn of different wavelengths, by connecting the output fiber 106 of a preceding OADM to the input fiber 105 of the following OADM. To function as a multiplxer, the signals of different wavelengths are sent into respective fibers 107-λx's, and sequentially combined by the OADMs 101-λx's (used as an “add” function) to output fiber 105-λ1 to form a composite signal, which is then transmitted through a single fiber down to the receiving end. To function as a demultiplexer, the composite signals (with all wavelengths) are sent into fiber 105-λ1, and specific wavelengths are sequentially separated by the OADM's 101-λx's (used as a “drop” function) to respective output fibers 107-λx's. This technology has become one of the most common ways in today's fiber optics component industry to implement CWDM or DWDM with channel number of 4, 8, or even 16.

When the WDM industry becomes extremely competitive and requires continuous cost reduction, while needing even smaller package size and higher reliability, the present invention becomes significant because it allows us to produce to a multiple-OADM device with the same number of components, which results in lower cost and smaller package size than conventional designs.

### SUMMARY OF THE INVENTION

This invention provides an OADM structure that has multiple number of input/output fibers compared to that of conventional OADM. Using this structure, one can make a 4-port OADM device using a half of the number of components as in conventional structure. In addition, one can implement a dual 4-port OADM using the same number of components for application in a two-fiber unidirectional communication system. Furthermore, one can make an integrated multiplexer/demultiplexer module for a two-fiber unidirectional communication system based on the current invention.

### BRIEF DESCRIPTION OF THE DRAWING

FIG. 1(a) is a conventional structure of a 3-port OADM;

FIG. 1(b) is a conventional structure of a 4-port OADM based on two identical 3-port OADMs;

FIG. 1(c) is a conventional structure of an n-channel WDM;

FIG. 1(d) is the output spectra of the 3-port and the 4-port OADMs;

FIG. 1(e) is a conventional uni-directional, two-fiber WDM communication system;

FIG. 1(f) is a conventional bi-directional WDM communication system utilizing optical circulators;

FIG. 2 is an embodiment of the present invention showing the structure of a 6-port OADM;

FIG. 3 is an embodiment of the present invention showing a singular 4-port OADM;

FIG. 4 is an embodiment of the present invention showing an integrated multiplexer/demultiplexer;

FIG. 5 is an embodiment of the present invention showing an 8-port optical device; and

FIGS. 6(a) and (b) are two embodiments of the present invention showing an extended 12-port and an 16-port optical devices.

FIGS. 7(a) and (b) are two embodiments of the present invention showing collimators with two fiber pairs with different fiber separation.

FIGS. 8(a) and (b) are two embodiments of the present invention showing collimators with four fiber pairs with different fiber separation.

FIGS. 9(a) and (b) are two embodiments of the present invention showing collimators with odd number of fiber ports to avoid receiving the reflected light from the filter.

### DETAILED DESCRIPTION OF PREFERRED EMBODIMENT(S)

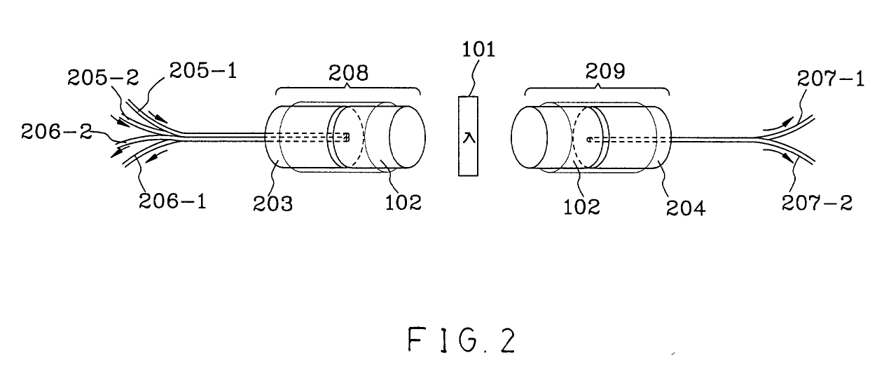

FIG. 2 shows the basic structure of the present invention for a 6-port optical device. A fiber pig-tail 203 with at least 4 fibers are inserted in the glass ferrule and polished and anti-reflection coated. The locations of the four fibers are such that each fiber has a counter-fiber located at the opposite position of the longitudinal axis of the front collimating lens 102. Due to the symmetric structure of the optical path, the output light from one fiber will be reflected by the WDM filter 101 (when positioned appropriately), and back into its counter-fiber. Therefore, the light from fiber 205-1 will be reflected back to fiber 206-1, and the light from fiber 205-2 will be reflected back to fiber 206-2. In the mean time, a second fiber collimator 209 with at least two output fibers 207-1 and 207-2 is appropriately position to received the transmitted light from fiber 205-1 and 205-2, respectively. Therefore, the combination of biers 205-1, 206-1, 207-1, and filter 101 resembles a conventional 3-port OADM, and the combination of fibers 205-2, 206-2, 207-2, and filter 101 resembles another conventional 3-port OADM. And the two 3-port OADMs are functioning independently with any optical interference. This structure thus provides two identical 3-port devices, while requiring the same number of components and space of only one conventional 3-port device.

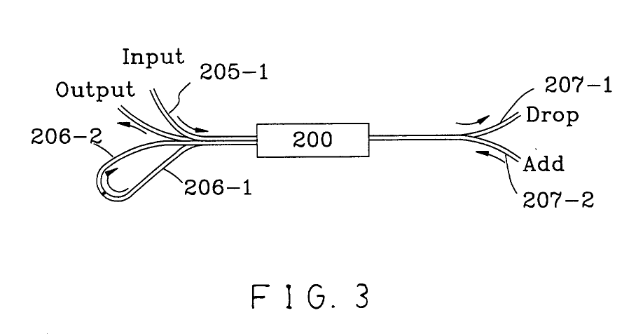

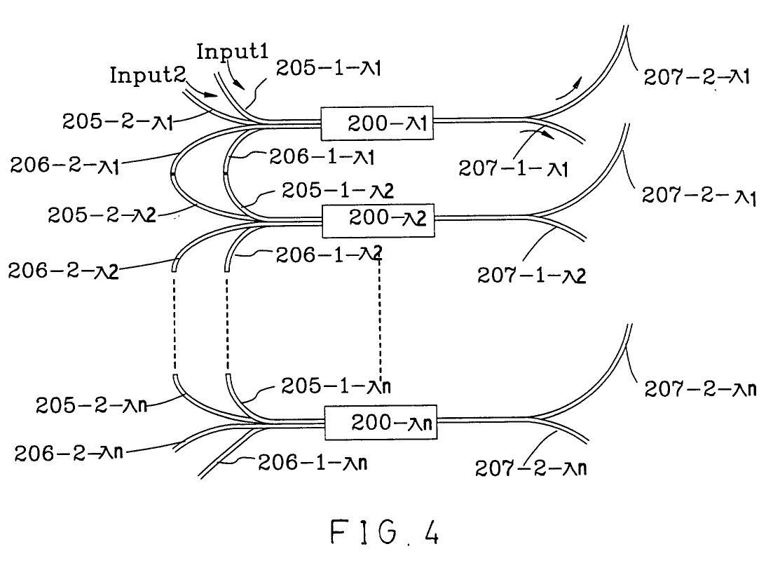

Utilizing the present invention, one can construct a 4-port add-and-drop module with one of such device, as shown in FIG. 3. By connecting two output fibers 206-1 and 206-2, one implement a 4-port OADM with fiber 205-1 as the input port, fiber 205-2 as the output port, fiber 207-1 as the drop port, and fiber 207-2 as the add port. The fiber connection between 206-1 and 206-2 can be made by either fusion splicing or mechanical splicing of the two fibers. Or it can be originally a single piece of fiber when the pig-tail 203 is fabricated. It should be noted that in order to maintain a low propagation loss in the fiber, the bending radius of the two fibers 206-1 and 206-2 needs to be kept at least 15 mm for a commercial communication fiber like, for example, SMF-28. This constrain results in a large foot print for the whole device package. In order to improve this situation, one can splice a section of high numberical aperture (high NA) fiber, which allows smaller bending radius and still maintains low light propagation loss, to fibers 206-1 and 106-2. This reduces the space required for the bending area, so the whole device can be packaged in a smaller (˜5-10) mm in diameter) package size. Another method is to use suitable fiber-thinning technique (e. G. tapered fusion or etching) to reduce the fiber diameter directly on the SMF-28 fiber, producing a high NA section and providing a miniature bend with low insertion loss, as described in U.S. Pat. No. 5,138,676. In both structures, the special fiber section can be integrated to the glass ferrule before the pig-tail is polished and AR coated in order to reduce the manufacturing difficulty.

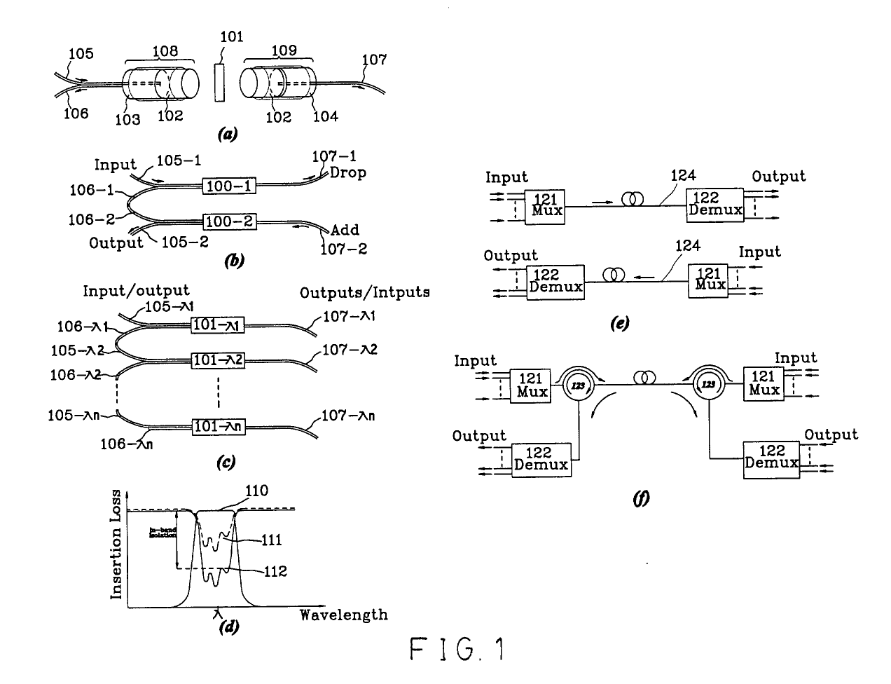

In most communication networks one needs to send information in both directions between two nodes. This can be accomplished by using a two-fiber design, as shown in FIG. 1(e), which comprises two identical uni-directional systems (each having one multiplexer 121, one demultiplexer 122, and the transmission fiber 124) except that the signals are traveling in the opposite directions. One can also use a single-fiber system, as shown in FIG. 1(f), in which an optical circulator 123 is used in each communication end to separate the optical signals traveling in opposite directions. This method has an advantage of using only one fiber in the transmission line, which results in significantly lower build cost if the transmission distance is very long. In both cases mentioned above, one needs a multiplexer module and a demultiplexer module on both transmission ends. Traditionally one can make two separate boxes for the multiplexer and the demultiplexer using conventional OADMs as in FIG. 1(c). However, using the present invention one can integrated the two boxes in one and only uses the same number of components as one demultiplexer. Such a structure is shown in FIG. 4 with a plurality of 6-port optical devices 200-λx's with different wavelengths. Because each 6-port device 200 represents two identical 3-port OADM's, one can realize two sets of multiplexer or demultiplexer if the 3-port OADM's are cascaded accordingly similar to FIG. 1(c). This device thus provides either two multiplexers, two demultiplexers, or a pair of muxtiplexer and demultiplexer (depending on the signal traveling direction) in one single package, significantly reducing the build cost.

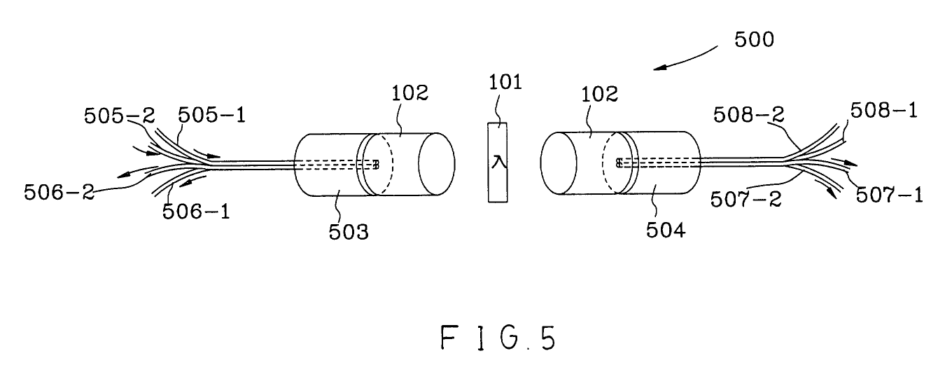

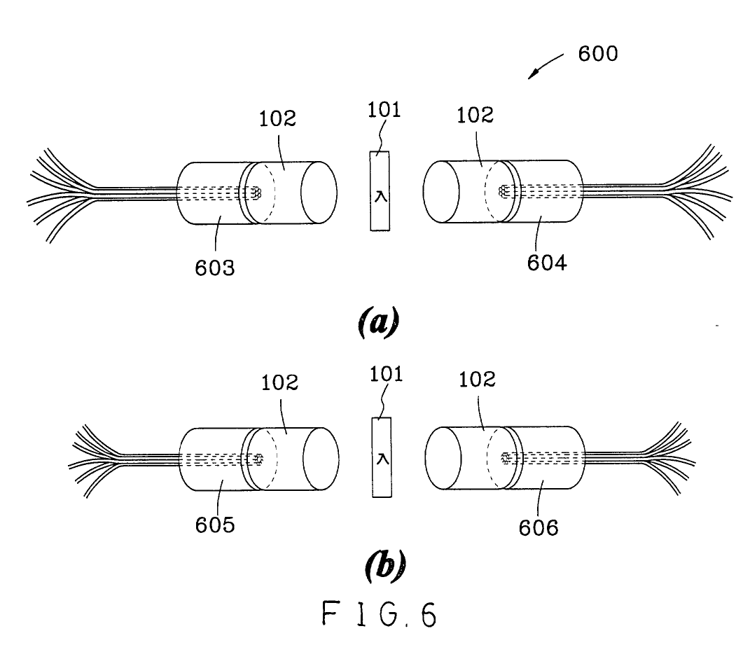

It is also possible to extend the present invention into a larger scale. For example, as shown in FIG. 5, the second collimator 504 can be constructed to have the same number of output fibers (4 in this case) as the first collimator 503. This performs similarly as FIG. 2 if two of the fibers at the second collimator are not used. Furthermore, a 12-fiber and a 16-fiber systems can be built based on the same concept, as shown in FIGS. 6(a) and 6(b). In both cases the fibers in the ferrules 603 or 605 are arranged in a circular fashion. Each fiber has a counter fiber in the opposition position of the longitudinal axis. Therefore a triple 3-port and quadruple 3-port OADM's can be realized (while half of the fibers at the second collimator are not used). Note that although other fiber arrangements can be used, it is desirable that the fiber separation of each pair is constant within each structure so the light incident angle on the filter 101 is also constant to maintain the center wavelength of the each output spectrum.

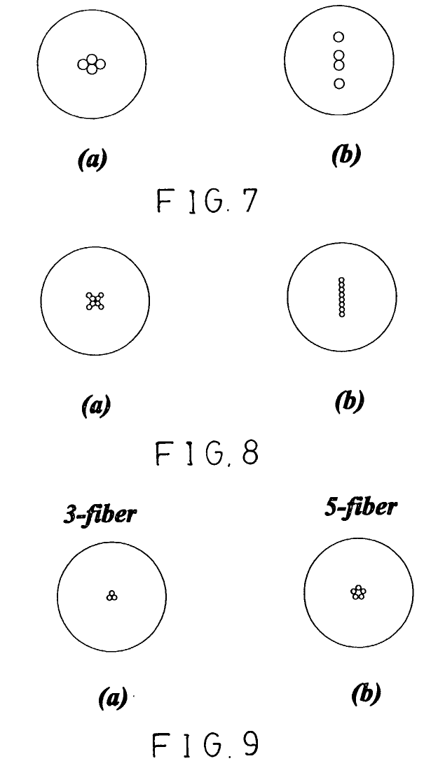

However, sometimes it is useful to have non-identical fiber center-to-center separation distance between the fiber pairs in the pig-tail. Two types of such arrangement are shown in FIGS. 7(a) and (b). In FIG. 7(a), the fiber center-to-center separation difference between the horizontal and vertical fiber-pairs is (\sqrt{3}−1) d=0.73205d, where d is the fiber diameter. In FIG. 7(b), the separation difference of the inner fiber-pair and outer fiber-pair can be easily adjusted by changing the ferrule design. It is well known that when the fiber distance changes, the light incident angle on the filter also changes, which results in a reflection and transmission spectra wavelength shift. It has been experimentally found that using a commercial 0.23 pitch GRIN lens with 1.8 mm diameter from NSG Corporation, when the fiber separation increases from 0.125 mm to 0.200 mm, the wavelength decreases almost linearly with a coefficient of ˜−6.1 nm/mm. Therefore, if the fibers in the pig-tail are arranged so that the fiber separation of two fiber-pairs has a difference of 0.06557 mm, the dual 3-port device will have two different center wavelengths separated by 0.4 nm. One possible arrangement is shown in FIG. 7(a), where the fiber center-to-center separation difference between the horizontal and vertical fiber-pairs is (\sqrt{3}−1) d=0.73205d, where d is the fiber diameter. Therefore, the desired 0.06557 mm difference corresponds to a fiber diameter of ˜0.090 mm, which can be easily obtained by, for example, chemical etching the commercial 0.125 mm fiber to the correct diameter. This structure is particularly useful because one of such device can replace two adjacent, conventional 3-port devices in FIG. 1(c) if the channel spacing of the multiplexer (or demultiplexer) is 0.4 nm, thus reducing the build cost and total size. A larger center wavelength difference like ˜1.6 nm can also be obtained using structure in FIG. 7(b) where the fiber separation is larger, but the actual distance will need to be determined for different collimating lenses. This approach, obviously, can be applied to structures with more that two fiber pairs, when some of the fiber pairs can have similar separation distance as one example shown in FIG. 8(a), or they are totally different as one example shown in FIG. 8(b).

Other useful optical components can also be realized, like an optical filter array, based on the present invention. Take FIG. 5 for example. Four different input light at fibers 505-1, 505-2, 505-3, and 505-4, pass through filter 101, and are received by output fibers 508-1, 508-2, 508-3, and 508-4, respectively. This, therefore, provides an in-line filter array of four identical elements with less number of conventional components. Non-identical wavelengths can also be obtained using collimator structures in FIG. 7 or FIG. 8. Practically, it is desirable to avoid the input light signal from one fiber being reflected to its counter fiber at the opposite position of the same collimator, so the input light sources are not interfered by the reflected lights. There are two methods to achieve this goal. The first method is to intentionally tilt the filter 101 slightly so the light is not accurately reflected to the fiber ports. The second method is to arrange the fiber in the pig-tail in a non-symmetric fashion. Two examples are shown in FIG. 9, where an odd number of three or five fibers can be used to provide the solution. The in-line filter can be gain-flattening filter or spontaneous emission noise filter for optical fiber amplifiers, or WDM filters for demultiplexers to increase signal isolation.

The above-described embodiments of the present inventio are merely meant to be illustrative and not limiting. It will thus be obvious to those skilled in the art that various changes and modifications may be made without departing from this invention in its broader aspects. For example, although specific numbers of output fibers were described for implementing the OADM and multiplexer/demultiplexer, any suitable combinations can be used to produce a specific OADM or multiplexer/demultiplexer structure in accordance with this invention. Therefore, the appended claims encompass all such changes and modifications as fall within the true spirit and scope of this invention.

What is claimed is:

1. An integrated optical add/drop module, comprising:
a first fiber collimator having a first and a second pair of fibers;
a second fiber collimator having a first and second drop fiber; and
a wavelength filter capable to allow light of a single wavelength to pass through the filter and further capable to reflect light having a wavelength not equal to the single wavelength, the filter positioned between the first and second collimators so as to
reflect, from a first fiber of a first pair to a second fiber of the first pair, light not having a wavelength equal to the single wavelength,
pass through, from a first fiber of the first pair to the first drop fiber, light having a wavelength equal to the single wavelength,
reflect, from a first fiber of a second pair to a second fiber of the second pair, light not having a wavelength equal to the single wavelength, and
pass through, from a first fiber of the second pair to the second drop fiber, light having a wavelength equal to the single wavelength.

2. An integrated optical add/drop module, comprising:
a first fiber collimator having a first and a second pair of fibers, a first fiber of the first pair being an input fiber, a first fiber of the second pair being an output fiber, a second fiber of the first pair being coupled to a second fiber of the second pair;
a second fiber collimator having a drop fiber and an add fiber; and
a wavelength filter capable to allow light of a single wavelength to pass through the filter and further capable to reflect light having a wavelength not equal to the single wavelength, the filter positioned between the first and second collimators so as to
reflect, from the first pair first fiber to the first pair second fiber, light not having a wavelength equal to the single wavelength,
pass through, from the first pair first fiber to the drop fiber, light having a wavelength equal to the single wavelength,
reflect, from the second pair second fiber to the second pair first fiber, light having a wavelength not equal to the single wavelength, and
pass through, from the add fiber to the second pair first fiber, light having a wavelength equal to the single wavelength.

3. An integrated optical add/drop module, comprising:
a first fiber collimator having at least four pairs of fibers;
a second fiber collimator having at least four fibers; and
a wavelength filter capable to allow light of a single wavelength to pass through the filter and further capable to reflect light having a wavelength not equal to the single wavelength, the filter positioned between the first and second collimators so as to
reflect, from first fibers of each of the first collimator pairs to a corresponding second fiber of each of the first collimator pairs light not having a wavelength equal to the single wavelength, and
pass through, from first fibers of each of the first collimator pairs to a corresponding fiber of the second collimator, light having a wavelength equal to the single wavelength.

4. The module of claim 2, wherein the second fiber of the first pair is coupled to the second fiber of the second pair via a low-loss miniature fiber bend.

5. The module of claim 4, wherein the miniature fiber bend comprises a high numerical aperture (NA) fiber.

6. The module of claim 4, wherein the miniature fiber bend comprises a diameter-reduced fiber.

7. The module of claim 1, 2, or 3, wherein the wavelength filter is positioned so as eliminate reflection coupling between fibers of the first collimator.

8. The module of claim 1, wherein the first collimator first pair second fiber is coupled to a first input fiber of a second module and wherein the first collimator second pair second fiber is coupled to a second input fiber of a second module.
